(19) United States
(12) Patent Application Publication
(10) Pub. No.: US 2026/0177714 A1
(43) Pub. Date: Jun. 25, 2026

(54) PREDICTING SITE CHARACTERIZATION PROPERTIES FOR EQUIPMENT FOUNDATIONS

(71) Applicant: Schlumberger Technology Corporation, Sugar Land, TX (US)

(72) Inventors: Ammar AHMAD, Crawley (GB); Klaus EDER, Vienna (AT); Annalisa CAMPANA, Clamart (FR); Sachin KRIPLANI, Esbjerg (DK); Sebastian THUM, Vienna (AT)

(21) Appl. No.: 19/124,317

(22) PCT Filed: Jun. 6, 2023
(86) PCT No.: PCT/US2023/068004

§ 371 Date: Apr. 25, 2025

Related U.S. Application Data
(60) Provisional application No. 63/381,202, filed on Oct. 27, 2022.

(51) Int. Cl. G01V 1/28; G01V 1/30; G01V 1/50; G01V 11/00; G01V 20/00

(52) U.S. Cl. CPC G01V 1/282; G01V 1/306; G01V 1/50; G01V 11/00; G01V 20/00

(57) ABSTRACT

The present disclosure describes a method for site characterization of offshore wind farms may include receiving, via at least one processor, a dataset comprising one or more cone penetrative test (CPT) properties associated with an area of interest (AOI) that corresponds to a seafloor. The method may also include generating, via the at least one processor, a geological process model comprising one or more rock layers and sediment information across the AOI based on one or more forward stratigraphic modeling techniques and geological information associated with the AOI. The method may also include applying, via the at least one processor, a machine learning algorithm to the geological process model to generate a predictive Earth model indicative of one or more site characteristics properties associated with a volume across the AOI.

### PRIORITY CLAIM

This application claims the priority benefit from U.S. Provisional Patent App. No. 63/381,202, filed on Oct. 27, 2022, which is incorporated by reference in its entirety.

### BACKGROUND

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

The present disclosure relates generally to generating site characterizations for an Area of Interest (AOI) based on predicted data. More specifically, the present disclosure relates to determining foundational characteristics of the sediment and rock layer properties to help facilitate the construction of different equipment, such as offshore windfarms and the like.

Determining site characteristics across an AOI may be challenging. The AOI may have complex geological structures and obtaining useable lithological data from the rock layers of the ocean floor may involve employing certain specialty testing methods that may be inefficient with respect to time and costs (e.g., financial, processing resources). That is, sediment and rock layer information may be obtained from one or more rock layers along the seabed across an AOI to determine the feasibility of foundation construction. Because of the number of tests that would be performed to obtain an accurate representation of rock layers corresponding the AOI, this process may be time consuming and costly to entities interested in building or securing equipment in an AOI. In some cases, statistical approaches may be taken to extrapolate previously taken data across a chosen AOI. However, these approaches may be limited in their predictive capacity and may not take into consideration the geological complexity of the sediment and its physical properties.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In a first embodiment, a method may include receiving, via at least one processor, a dataset comprising one or more cone penetrative test (CPT) properties associated with an area of interest (AOI) that corresponds to a seafloor. The method may also include generating, via the at least one processor, a geological process model comprising one or more rock layers and sediment information across the AOI based on one or more forward stratigraphic modeling techniques and geological information associated with the AOI. The method may also include applying, via the at least one processor, a machine learning algorithm to the geological process model to generate a predictive Earth model indicative of one or more site characteristics properties associated with a volume across the AOI.

In some embodiments, the one or more site characteristics properties may include one or more probability quantities, one or more uncertainty volumes, or any combination thereof associated with the one or more rock layers in the volume across the AOI.

In some embodiments, the geological information may include sediment data, rock layer data, or both.

In some embodiments, the geological information may include erosion data, current data, salinity data, rock strength data, rock age data, rock density data, rock corrosiveness data, rock porosity data, or any combination thereof.

In some embodiments, the method may further include receiving, via the at least one processor, seismic data associated with the AOI. The method may also include extracting, via the at least one processor, lithological density data associated with the AOI based on the geological process model. Additionally, the method may include generating, via the at least one processor, rock layer porosity volume data associated with the AOI based on the lithological density data.

The method may further include determining, via the at least one processor, a rock strength profile across the AOI based on the seismic data and the rock layer porosity volume data. The method may also include updating, via the at least one processor, the predictive Earth model to include one or more rock strength properties across the volume of the AOI based on the rock strength profile.

In some embodiments, the method may further include generating predicted lithological dataset associated with the AOI by applying one or more forward stratigraphic modeling techniques to the dataset. The method may also include generating the geological process model based on the predicted lithological dataset.

In some embodiments, the geological process model is representative of one or more physical changes of one or more rock layers in the AOI over a period of time.

In some embodiments, the geological process model is used as training data for the machine learning algorithm to predict the one or more site characteristics properties associated with the volume across the AOI.

In a second embodiment, a computer program may include computer-executable instructions that, when executed, are configured to cause at least one processor to perform operations that may include receiving seismic data associated with an area of interest (AOI) and a geological process model indicative of information related to one or more rock layers and sediment information across an area of interest (AOI). The operations may include extracting lithological density data associated with the AOI based on the geological process model. The operations may further include generating rock layer porosity volume data associated with the AOI based on the lithological density data. Additionally, the operations may include determining a rock strength profile across the AOI based on the seismic data and the rock layer porosity volume data. The operations may also include generating a predictive Earth model comprising one or more rock strength properties across a volume of the AOI based on the rock strength profile and the geological process model.

In some embodiments, the seismic data may include one or more p-wave datasets associated with the one or more rock layers.

In some embodiments, the rock strength profile is determined based on a best fit line equation associated with a cross plot between the one or more p-wave datasets and the rock layer porosity volume data.

In some embodiments, the rock strength profile is determined based on a cross plot between one or more p-wave velocity data points of the seismic data and one or more rock layer porosity volume data points of the geological process model.

In some embodiments, the computer-executable instructions are configured to cause the at least one processor to perform operations comprising applying one or more interpolation methods, one or more extrapolations methods, or both to the cross plot to generate one or more predicted values for the one or more rock strength properties.

In some embodiments, the geological process model is representative of one or more physical changes of one or more rock layers in the AOI over a period of time.

In a third embodiment, a computer program comprising computer-executable instructions that, when executed, are configured to cause at least one processor to perform operations may include receiving a dataset comprising one or more cone penetrative test (CPT) properties associated with an area of interest (AOI) that corresponds to a seafloor. The operations may include generating, via the at least one processor, a geological process model comprising lithological density data associated the AOI based on one or more forward stratigraphic modeling techniques and geological information associated with the AOI. The operations may involve applying, via the at least one processor, a machine learning algorithm to the geological process model to generate a predictive Earth model indicative of one or more site characteristics properties associated with a volume across the AOI. The operations may also include updating the predictive Earth model to include one or more rock strength properties across the volume of the AOI based on seismic data associated with the AOI and the lithological density data.

In some embodiments, the computer-executable instructions are configured to cause the at least one processor to perform the operations that may further include generating rock layer porosity volume data associated with the AOI based on the lithological density data. The operations may also include determining a rock strength profile across the AOI based on the seismic data and the rock layer porosity volume data. Additionally, the operations may include updating the predictive Earth model to include the one or more rock strength properties across the volume of the AOI based on the rock strength profile.

In some embodiments, the one or more rock strength properties may include stresses, strains, or both associated with material failure of one or more rock layer across the volume of the AOI.

In some embodiments, the geological process model may be used as training data for the machine learning algorithm to predict the one or more site characteristics properties associated with the volume across the AOI.

In some embodiments, the geological process model may be generated based on a predicted lithological dataset associated with the AOI, in which the predicted lithological dataset is determined by applying one or more forward stratigraphic modeling techniques to the dataset to generate.

In some embodiments, the dataset may also include a high-resolution grid generated by upscaling the one or more CPT properties.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWING

These and other features, aspects, and advantages of the present disclosure will become better understood when the following detailed description is read with reference to the accompanying drawings in which like characters represent like parts throughout the drawings, wherein:

FIG. 1 illustrates a schematic view, partially in cross section, of a system for determining site characterization properties of an Area of Interest (AOI), in accordance with an aspect of the present disclosure;

FIG. 2 illustrates a block diagram of a site characterization system and other connected components, in accordance with an aspect of the present disclosure;

FIG. 3 illustrates a process flow diagram of a method for determining site characterization properties of an Area of Interest (AOI), in accordance with an aspect of the present disclosure; and

FIG. 4 illustrates a process flow diagram of a method for determining a rock strength profile of an Area of Interest (AOI), in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. It should be noted that the term “multimedia” and “media” may be used interchangeably herein.

Offshore wind farms can generate a significant amount of power, as compared to their onshore counterparts. However, challenges remain in characterizing potential sites in which offshore windfarms may be constructed. Indeed, current site characterization methodologies may involve taking sediment information from various rock layers along a seabed at several points in an Area of Interest (AOI), interpreting the sediment information through certain geostatistical algorithms, and making predictions about the sediment, piling foundations, and other site characteristics of the seabed to determine the feasibility of constructing an offshore wind farm at the respective site.

One type of sediment information related to the sea floor may be acquired based on lithological data points obtained from a Cone Penetration Test (CPT). In a CPT, a “cone” is pushed down into the sediment at a constant speed, and the force required to continue moving the cone at that speed is recorded at each depth. Different sediment types give different resistances to the cone and the sediment characteristics in the area near the cone can be determined at each depth for the length of the cone. The CPT operation may be performed in any suitable AOI, which may correspond to any location in which the feasibility of constructing an offshore wind farm may be studied. These AOIs may be on the scale of, but not limited to, 500 square kilometers to 1000 square kilometers in area and 50 meters to 100 meters in depth. With this in mind, the process workflow for performing site characterization operations in an AOI may involve a considerable amount of time and computing resources based on the CPT operations and corresponding geostatistical algorithms and interpolation methods used to make predictions about the respective site.

To perform site characterizations of seafloors more efficiently, the presently disclosed embodiments detail employing forward stratigraphic models that utilize principles of mass and energy conservation to make predictions for the shallow sediments of the respective seafloor. These sediment predictions can include, but are not limited to, whether the sediment is course or smooth, whether there is a high or low clay concentration, strength characteristics of the rock layers beneath the surface, and the like. Using the sample geological information (e.g., CPT properties) in certain locations acquired in the AOI (e.g., via CPT processes), a computing system may apply forward stratigraphic modeling techniques to the sample sediment information or other suitable data to generate a geological process model or a predictive forward stratigraphic model related to properties of the sediment across the AOI. As such, in some embodiments, the geological process model may include predicted information regarding of rock layers and sediment in the AOI based on known geological information (e.g., CPT properties). Geological information may include rock porosity data, rock erosion data, rock strength data, rock age data, rock density data, rock corrosiveness data, salt content data, water current data, and the like

After generating the geological process model, the computing system applies a machine learning algorithm or methodology to the geological process model to propagate probability quantiles and uncertainty volumes related to rock layer and sediment information across a volume of the AOI. By using the geological process model (e.g., predictive forward stratigraphic model) as training data for the machine learning algorithm, the computing system may generate a predictive Earth model for site characterizations that produces rock layer and sediment information across a volume of the AOI. The predictive Earth model may be used by various entities to determine various site characterization properties in a more efficient manner, as compared to interpolation techniques using the CPT properties. Using the site characterization properties, these entities can more easily determine whether the sediment is suitable for construction of an offshore wind farm in a particular AOI. Moreover, because the presently described embodiments involve fewer statistical analyses processes as compared to employing statistical functions related to CPT properties, the site characterization properties are determined in a more time efficient and computing resource efficient manner.

In addition to determining the rock layer and sediment information across the AOI, the present embodiments may also be employed to determine a rock strength profile associated with the rock layers along a seabed of the AOI or other site characterization properties that may be used to determine whether the sediment is suitable for construction of an offshore wind farm. The amount of time that an offshore wind turbine may operate is related to the strength of the rocks upon which the foundation associated with the offshore wind turbine is built. That is, a first wind turbine that may operate within foundation built upon the rock layers along a seabed corresponding to a first rock strength profile indicating high strength may operate for a longer period of time than a second wind turbine with foundation built upon the rock layers along a seabed corresponding to a second rock strength profile indicating low strength. Therefore, obtaining an accurate rock strength profile is useful in predicting a suitable AOI from a variety of AOIs.

One method to obtain the accurate rock strength profile uses physical samples obtained from a particular AOI (e.g., via CPT processes) to measure physical sample sediment information (e.g., CPT properties). The physical sample sediment information may include the rock density of the rock layers along the seabed of the particular AOI. With all of this in mind, the process to determine a rock strength profile is time consuming and creates additional costs to the entities characterizing a particular AOI through additional labor, transportation, testing, and the like.

Keeping this in mind, to determine the rock strength profile of the seabed more efficiently, the presently disclosed embodiment details employing predictive forward stratigraphic models that utilize principles of mass and energy conservation to compute predicted rock density data of the rock layers across the AOI. Indeed, in some embodiments, the computing system may employ a geological process model to generate a predictive rock layer model related to lithological density properties of the rock layers across the AOI. After generating the predictive rock layer model, the computing system may then determine rock layer porosity volume data based on the lithological density data as indicated in the predictive rock layer model. After determining the rock layer porosity volume data, the computing system may use the relationship between the rock layer porosity data and seismic data (e.g., obtained via seismic data acquisition techniques) to predict the rock strength for the rock layers across an AOI. In some embodiments, the seismic data may include primary wave (p-wave) velocity data. The p-wave velocity data may include a direction and a speed of primary seismic waves traveling through the rock layers across an AOI.

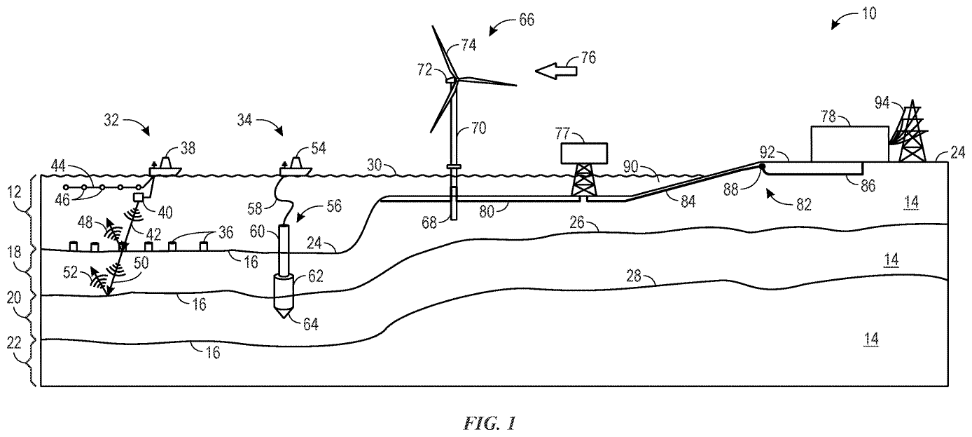

The computing system may receive the p-wave velocity data throughout the presently described embodiment. Using the p-wave velocity data (e.g., obtained via seismic data acquisition techniques) and the porosity volume data (e.g., obtained via predicted rock density data), a cross plot may be generated to determine a relationship between the two sets of data. In some embodiments, a best fit line may be generated to interpolate between individual data points and form a best fit line equation that illustrates the relationship between the two sets of data. Using the best fit line equation, the rock strength may be calculated and propagated across the AOI so that the computing system may generate a rock strength profile across the volume of the AOI. The computing system may then generate a predictive Earth model with rock strength properties based on the rock strength profile. The predictive Earth models with rock strength properties may be used by various entities to make quantitative predictions on areas of foundational stability across the associated AOI. The quantitative predictions on areas of foundational stability from the associated earth model may reduce the number of physical sample tests used throughout the AOI (e.g. via CPT processes), improving overall efficiency. Additional details with regard to determining site characterization properties and rock strength properties will be discussed below with reference to FIGS. 1-4.

By way of introduction, turning now to the figures, FIG. 1 illustrates a schematic view of system 10 for determining site characterization properties of an Area of Interest (AOI). Referring to FIG. 1, the system 10 may include a body of water 12 as well as one or more rock layers 14. The one or more rock layers 14 may be distinct from one another and one or more rock layer surfaces 16 may be used to identify the rock layers 14. In the illustrated embodiment, the AOI includes a first rock layer 18, a second rock layer 20, and a third rock layer 22. The one or more rock layers 14 and the body of water 12 are separated in the illustrated embodiment by the one or more rock layer surfaces 16. The body of water 12 and the first rock layer 18 are separated via the first rock layer surface 24, the first rock layer 18 and the second rock layer 20 are separated via the second rock layer surface 26, and the second rock layer 20 and the third rock layer 22 are separated via the third rock layer surface 28. The one or more rock layer surfaces 16 may be defined at certain depths within the of the one or more rock layers 14 that correspond to classifications of sediment and lithological data. For example, the first rock layer 18 may be classified by the majority of the sediment being shale based on lithological data. The second rock layer 20 may be classified by the majority of the sediment being limestone based on lithological data. In some embodiments, the second rock layer surface 26 may be associated with the depth at which the sediment transitions from majority-shale to majority-limestone. Additionally, the body of water 12 will have a water surface 30. It should be appreciated that the illustrated embodiment in FIG. 1 may not be to scale and that the following described elements may not be oriented in the same order in another embodiment of the system 10.

In some embodiments, the one or more rock layers 14 may be relatively lithologically distinct from one another. The one or more rock layers 14 may be sedimentary rock layers related to a time period in which the respective rock layer was formed. In other embodiments, the one or more rock layers 14 may be relatively lithologically similar to one another. Distinctions between the one or more rock layers 14 may be made by a rock layer property that is not associated with the physical properties of the one or more rock layers 14.

Keeping the foregoing in mind, the AOI depicted in the system 10 may be the site of testing procedures in order to determine lithological and seismic data for the one or more rock layers 14. These testing procedures may include marine seismic data surveys 32, cone penetrative test (CPT) surveys 34, and the like. In addition, the testing procedures and data analysis described herein may also be performed using seismic data acquired via land seismic data surveys and the like.

Referring first to the marine seismic data surveys 32, the marine seismic data surveys 32 may include ocean bottom node (OBN) measurement by employing multiple OBNs 36 on the first rock layer surface 24. The OBNs 36 may be deployed (e.g., using remotely operated vehicles (ROVs)) to selected locations and form a certain geometry (e.g., an OBN patch with 200 meters by 200 meters grid size). Each of the OBNs 36 may include one or more OBN sensors. The OBN sensors may include one or more geophones (e.g., three-component geophones). In some embodiment, the OBN sensors may also include hydrophones.

In addition, the marine seismic data surveys 32 may employ one or more seismic source vessels 38. For example, a seismic source vessel 38 towing a seismic source 40 may be used to create seismic waves 42 propagating downward into the one or more rock layers 14. Each of the seismic sources 40 may include one or more source arrays and each source array may include a certain number of sources (e.g., air guns, marine vibrators, etc.).

The marine seismic data survey 32 may also include streamer measurement by employing multiple seismic streamers 44 traversing the water. For example, the seismic source vessel 38 may tow multiple (e.g., two, four, six, eight, or ten) seismic streamers 44 along one sail line, and the seismic source vessel 38 may tow multiple seismic streamers 44 along another sail line. The streamer measurement may be acquired independently or simultaneously with the OBN measurements using shots fired by the seismic sources 40. Each of the seismic streamers 44 may include multiple streamer sensors 46. The streamer sensors 46 may include hydrophones or other suitable sensors that create electrical signals in response to water pressure changes caused by reflected seismic waves that arrive to the hydrophones.

During the marine seismic data survey 32, the seismic source 40 may be activated to generate seismic waves 42 traveling downward into the one or more rock layers 14. When the seismic waves 42 arrives at the first rock layer surface 24, a portion of seismic energy contained in the seismic waves 42 is reflected by the first rock layer surface 24. Reflected waves 48 travel upward and arrive at different sensors, such as the streamer sensors 46, where the reflected waves 48 are measured by corresponding sensors. Another portion of the seismic energy contained in transmitted seismic waves 50 propagated through the first rock layer surface 24 into the second rock layer 20. A portion of seismic energy contained in the transmitted seismic waves 50 is reflected by the second rock layer surface 26. Reflected waves 52 travel upward and arrive at the different sensors, such as the streamer sensors 46, where the reflected waves 52 are measured by the corresponding sensors.

In some embodiments, the transmitted seismic waves 50 may include primary waves (p-waves) and secondary waves (s-waves). The p-waves may transmit through the one or more rock layers 14 at a faster speed than the s-waves. In this way, the p-waves may be the first seismic waves to reflect off of the next lowest rock layer surface and arrive at the different sensors, such as the streamer sensors 46. In some embodiments, the sensors may be designated as p-wave sensors and as s-wave sensors, in which the p-wave sensors are disposed to measure data from the reflected p-waves, and the s-wave sensors are disposed to measure data from the reflected s-waves.

The portion of the seismic energy that is transmitted through the rock layer as opposed to being reflected from the rock layer may vary between embodiments. For example, if the first rock layer 18 is relatively reflective to seismic waves compared to the body of water 12, a larger portion of the seismic energy may reflect off of the first rock layer surface 24 as the reflected waves 48. Conversely, if the second rock layer 20 is relatively transmissive to seismic waves compared to the first rock layer 18, a larger portion of the seismic energy may transmit through the second rock layer surface 26 as the transmitted seismic waves 50. In some embodiments, the transmissivity and reflectivity of the one or more rock layers 14 may limit the depth of which the seismic energy is able to be transmitted. For example, if the one or more rock layers 14 are relatively transmissive to the seismic waves, the seismic energy may reach a deeper rock layer than if the one or more rock layers 14 are relatively reflective to the seismic waves.

It should be noted that the elements described above with regard to the marine seismic data survey 32 are exemplary elements. For instance, some embodiments of the marine seismic data survey 32 may include additional or fewer elements than those shown. In some embodiments, the marine seismic data survey 32 may include a different number of seismic source vessels 38. In some embodiments, separated receiver vessels may be used to tow the streamers.

With regard to the CPT survey 34, one or more CPT vessels 54 may be used to acquire CPT data. For example, a CPT vessel 54 may provide power to an instrumented cone 56 in the one or more rock layers 14 via a CPT cable 58. The instrumented cone 56 may include a rod 60 that provides a force that pushes the instrumented cone 56 into the sediment. The instrumented cone 56 may also include a friction sleeve 62. The friction sleeve 62 may quantify an amount of friction experienced by the instrumented cone 56 as the instrumented cone 56 passes through a distinct rock layer. In this way, the friction sleeve 62 can provide valuable information as to the lithological characteristics of the one or more rock layers 14. The instrumented cone 56 may also include a cone tip 64 that may lower the required amount of force supplied via the rod 60 and increase the depth at which the friction sleeve 62 may take lithological measurements.

By way of operation of the CPT survey 34, the CPT vessel 54 may position itself above a specific location in the AOI that is of interest to an entity. The CPT vessel 54 may deploy the instrumented cone 56 to be directed with the cone tip 64 in contact with the first rock layer surface 24 and the rod 60 and friction sleeve 62 extending upwards. The CPT vessel 54 may include a power source that generates a force in the rod 60 via the CPT cable 58 that pushes the instrumented cone 56 through the first rock layer surface 24 and into the first rock layer 18. The rod 60 continues to provide a force that pushes the instrumented cone 56 further downward at a continuous speed. In this way, the friction sleeve 62 may determine the amount of friction caused by the surrounding rock layers with the speed of the instrumented cone 56 acting as a controlled variable. The friction sleeve 62 may continue recording the friction as the instrumented cone 56 is pushed through the first rock layer 18 and the cone tip 64 makes contact with the second rock layer surface 26. The instrumented cone 56 may continue downward through the second rock layer surface 26 and into the second rock layer 20. The friction sleeve 62 may continue recording the amount of friction as the instrumented cone 56 passes between rock layers. If the one or more rock layers 14 are lithologically distinct, the friction sleeve 62 may record a change in average friction as the instrumented cone 56 passes between them. In this way, the instrumented cone 56 may identify the depth at which the first rock layer 18 transitions to the second rock layer 20 as well as lithological data with regards to each distinct rock layer.

It should be noted that the elements described above with regard to the CPT survey 34 are exemplary elements. For instance, some embodiments of the CPT survey 34 may include additional or fewer elements than those shown. In some embodiments, the CPT survey 34 may include a different number of CPT vessels 54. In some embodiments, each CPT vessel 54 may have a different number of CPT cables 58 leading to one or more instrumented cones 56 at different specific locations. In some embodiments, the CPT cables 58 may also communicate data (e.g., instructional commands, lithological data, depth data, speed data, etc.) between the instrumented cone 56 and the CPT vessel 54.

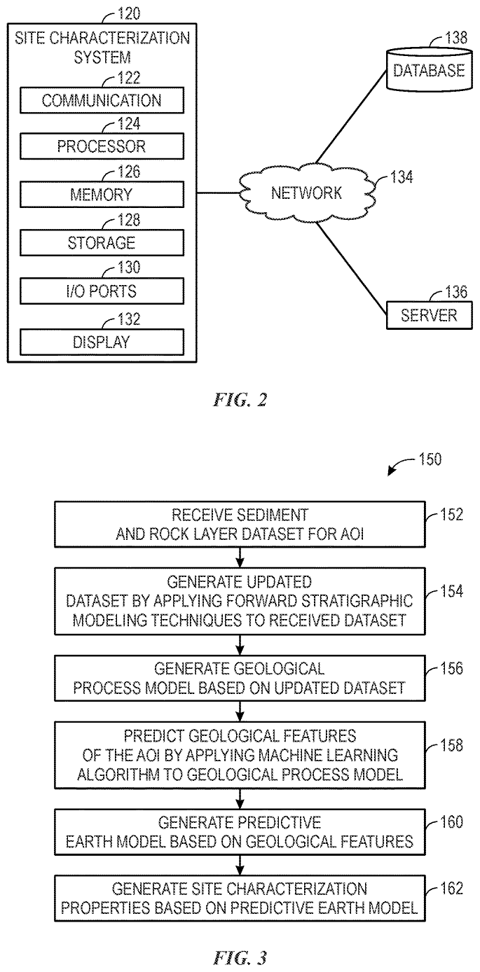

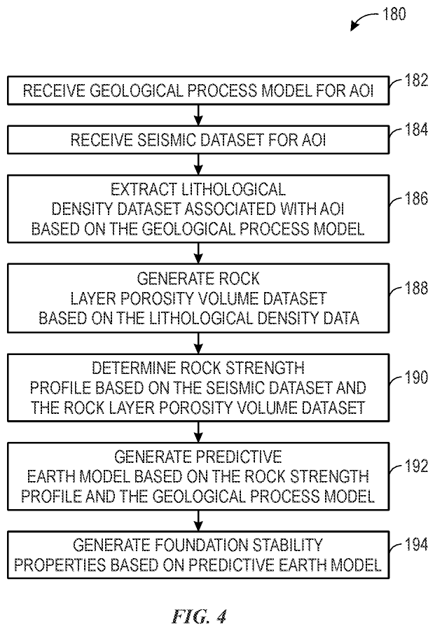

In some embodiments, the AOI may be the site of an offshore wind farm. Data collected from the marine seismic data survey 32 and the CPT survey 34 may influence whether or not the AOI is chosen to for the site of the offshore wind farm. In some embodiments, the collected data may be used as an input for a method for site characterization as will be detailed below with reference to FIGS. 3 and 4. In some embodiments, the method for site characterization may generate site characterization properties (e.g., rock strength, erosion patterns, water corrosiveness, water current velocity, etc.) that indicate whether the AOI is suitable for an offshore wind farm.

The offshore wind farm may include one or more wind turbines 66 situated in the AOI and held at a set location in the AOI within some proximity to the one or more rock layers 14. The wind turbine 66 may include a turbine foundation 68, which is embedded within the one or more rock layers 14, as well as a support tower 70 leading from the turbine foundation 68 to a turbine generator 72. The turbine generator 72 is coupled to one or more turbine blades 74 that may rotate as the turbine blades 74 receive an air flow 76 across them. In this way, the wind turbine 66 may generate power from the air flow 76.

The turbine foundation 68 may be deep enough to extend throughout the one or more rock layers 14. The illustrated embodiment depicts the turbine foundation 68 residing within the first rock layer 18, but in some other embodiment, the turbine foundation 68 may extend into the second rock layer 20 and/or into the third rock layer 22.

The stability granted to the wind turbine 66 through the turbine foundation 68 may be useful for determining the expected lifespan of the wind turbine 66. As mentioned earlier, the wind turbine 66 with the turbine foundation 68 built in one or more rock layers 14 with a lower relative rock strength may not be operational for as long as a wind turbine 66 with the turbine foundation 68 built in a one or more rock layers 14 with a higher relative rock strength. For example, the illustrated embodiment depicts a wind turbine 66 with a monopole-style turbine foundation 68 (e.g., a single support tower extending from the generator into the rock layers). As the turbine blades 74 spin when an air flow is directed across them, the rotating turbine blades 74 create a physical moment in the turbine foundation 68. With a relatively strong turbine foundation 68, the physical moment may not cause the support tower 70 to rotate in the direction of the created moment.

The offshore wind farm may include an offshore substation 77. The offshore substation 77 may collect generated power from the one or more wind turbines 66 before exporting the collected power to an onshore substation 78. The offshore substation 77 may also have foundational support built into the one or more rock layers 14. The offshore substation 77 and the one or more wind turbines 66 may be in electrical communication via an offshore cable array 80. The offshore cable array 80 may be distributed throughout the AOI and may be embedded within the one or more rock layers 14. In this way, the offshore cable array 80 and the offshore substation 77 may both be safely secured with a lower risk of either one becoming loose and affected by the ocean currents. The onshore substation 78 and the offshore substation 77 may be in electrical communication via an export cable array 82. The export cable array 82 may include an offshore export cable 84, an onshore export cable 86, and a cable landing point 88. The offshore export cable 84 may be in electrical communication with the offshore substation 77 and may be embedded within the one or more rock layers 14 of the transition zone 90 between the body of water 12 and the shore 92. After reaching the shore 92, the offshore export cable 84 may reach a cable landing point 88 that is in electrical communication with the onshore substation 78 via the onshore export cable 86. The onshore export cable 86 may also be embedded within the one or more rock layers 14. In this way, the offshore substation 77 may transport the collected power from the one or more wind turbines 66 to the onshore substation 78. The onshore substation 78 may then distribute the collected power out of the AOI via one or more power lines 94.

Offshore wind farms are able to generate large amounts of power from the air flow 76 above the body of water surface 30 and distribute that power out of the AOI to be used by entities outside of the AOI. Across the offshore wind farm, multiple elements (e.g., the turbine foundation 68, the offshore array cable, the offshore substation 77, the offshore export cable 84, the onshore export cable 86) rely upon known site characterization properties associated with the ocean floor sediment and the one or more rock layers 14 across the AOI (e.g., below the body of water, in the transition zone, on shore).

With the foregoing in mind, the data acquired via the marine seismic data survey 32, the CPT survey 34, and other data sources may be used to determine the site characterization properties of the AOI. Referring now to FIG. 2, the site characterization system 120 may include any suitable computing device, cloud-computing device, or the like and may include various components to perform various analysis operations related to performing the embodiments described herein. By way of example, the site characterization system 120 may include a communication component 122, a processor 124, a memory 126, a storage component 128, input/output (I/O) ports 130, a display 132, and the like. The communication component 122 may be a wireless or wired communication component that may facilitate communication between different monitoring systems, gateway communication devices, various control systems, and the like. The processor 124 may be any type of computer processor (e.g., multi-core) or microprocessor capable of executing computer-executable code. The memory 126 and the storage component 128 may be any suitable articles of manufacture that can serve as media to store processor-executable code, data, or the like. These articles of manufacture may represent non-transitory computer-readable media (i.e., any suitable form of memory or storage) that may store the processor-executable code used by the processor 124 to perform the presently disclosed techniques. The memory 126 and the storage component 128 may also be used to store data received via the I/O ports 130, data analyzed by the processor 124, or the like.

The I/O ports 130 may be interfaces that may couple to various types of I/O modules such as sensors, programmable logic controllers (PLC), and other types of equipment. For example, the I/O ports 130 may serve as an interface to pressure sensors, flow sensors, temperature sensors, seismic sensors, friction sensors, and the like. As such, the site characterization system 120 may receive lithological data associated with the one or more rock layers 14 via the I/O ports 130. The I/O ports 130 may also serve as an interface to enable the site characterization system 120 to connect and communicate with surface instrumentation, servers, and the like.

The display 132 may include any type of electronic display such as a liquid crystal display, a light-emitting-diode display, and the like. As such, data acquired via the I/O ports and/or data analyzed by the processor 124 may be presented on the display 132, such that the site characterization system 120 may present site characterization properties for the AOI for view. In certain embodiments, the display 132 may be a touch screen display or any other type of display capable of receiving inputs from an operator. Although the site characterization system 120 is described as including the components presented in FIG. 2, the site characterization system 120 should not be limited to including the components listed in FIG. 2. Indeed, the site characterization system 120 may include additional or fewer components than described above.

It should also be noted that for the sake of modularity and flexibility with regard to both the size and specifications of generating site characterization properties, the site characterization system 120 may be implemented over a web application with back-end and front-end components. In this scheme, the back-end component may be responsible for handling certain predictive algorithms and modeling techniques, while the front-end component may be used to set a geological process model specifications and parameters from a user's perspective as detailed further below. The communication between the front-end component and back-end component of the site characterization system 120 may involve communications over any suitable network 134.

The site characterization system 120 may also include a one or more remote servers, as shown in the illustrated embodiment as a server 136. The server 136 may communicate with the site characterization system 120 via the network 134. In some embodiments, the site characterization system 120 may employ the server 136 to assist the site characterization system 120 in apply modeling techniques and algorithms to the received data and to reduce computing power required of the site characterization system 120. Similarly, the site characterization system 120 may also include one or more databases, as shown in the illustrated embodiment as a database 138. The database 138 may receive, send, and store relevant data to the site characterization system 120. For example, the first database may store a seismic dataset based on the results of a marine seismic data survey 32. The site characterization system 120 may request the seismic dataset and receive the seismic dataset at a time after the seismic dataset had been recorded and sent to the database 138.

With the foregoing in mind, the site characterization system 120 may implement a method to generate site characterization properties across an AOI. For instance, the site characterization system 120 may receive sediment and rock layer data associated with specific locations in the AOI. The sediment and rock layer data may be obtained through one or more testing methods (e.g., marine seismic data survey 32, CPT survey 34, etc.). Moreover, the site characterization system 120 may apply forward stratigraphic modeling techniques to the one or more received datasets in order to generate a geological process model. The site characterization system 120 may also apply machine learning algorithms to the geological process model to generate a predictive Earth model. The predictive Earth model may include site characterization properties for view via the display 132. The predictive Earth model may be used by various entities to determine the feasibility and plan the construction of foundations for various types of equipment, such as the offshore windfarm.

With this in mind, FIG. 3 illustrates a flow chart of a method 150 for determining site characterization properties of an AOI. Although the following description of the method 150 is described as being performed by the site characterization system 120, it should be understood that any suitable computing system may perform the method 150. Additionally, although the method 150 is described in a particular order, it should be noted that the method 150 may be performed in any suitable order.

Referring now to FIG. 3, at block 152, the site characterization system 120 may receive one or more sediment datasets associated with the AOI and one or more rock layer datasets associated with the AOI. The sediment datasets and the rock layer datasets may include lithological data associated with the one or more rock layers 14 of the AOI. The lithological data may include information related to the character or physical characteristics (e.g., color, texture, grain size, composition) of rocks. The sediment dataset may include information related to the movement of solid material in the AOI. As such, the sediment dataset may provide insight into the movement of rocks, minerals, remains of living things, and the like. The sediment may encompass sizes from as small as a grain of sand to as large as a boulder.

In some embodiments, to acquire the sediment and rock layer datasets, the site characterization system 120 may receive first receive input data related to the sediments and/or rocks in the AOI. The site characterization system 120 may then use the input data to generate the sediment and rock layer datasets.

By way of example, the input data may be obtained through one or more testing or surveying methods. For example, the input data may be obtained via the marine seismic data surveys 32, the CPT surveys 34, geochronology surveys, gravity surveys, salt proximity surveys, and the like. The testing and surveying methods may obtain lithological data associated with the sediment and rock layers of the AOI where the testing and surveying methods are performed. The different testing and surveying methods may provide different types of lithological data (e.g., CPT properties) for a location within the AOI. For example, the input data may include rock porosity data, rock strength data, rock age data, rock density data, rock corrosiveness data, salt content data, and the like. The input data points may be different at different locations across an AOI. For example, a first input data point obtained via CPT surveying methods in the southern hemisphere of an AOI may be lithologically distinct from a second input data point obtained via CPT surveying methods in the northern hemisphere of an AOI. Similarly, data inputs taken at different depths in a similar location may obtain different input data. For example, testing the salt content of a location in an AOI at a depth of 10 meters may obtain different input data than testing the salt content at a depth of 20 meters. In both cases, the input data obtained may be used in the site characterization system 120. In some embodiments, the input data may be obtained for the purpose of site characterization of an AOI within the system 10. In other embodiments, the input data may be repurposed data obtained for purposes beyond the scope of the present disclosure. The site characterization system 120 may receive relevant input data for site characterization from one or more entities and during one or more timeframes.

In addition, the site characterization system 120 may also populate a high-resolution grid based on the received input data. In some embodiments, the site characterization system 120 may receive a pre-constructed high-resolution grid from a storage source accessible via the server 136 associated with the site characterization system 120, the database 138 associated with the site characterization system 120, and other suitable storage components associated with the site characterization system 120. The high-resolution grid may be constructed with relation to the dimensions of the AOI. For example, a high-resolution grid associated with an AOI that is 20 square kilometers may be differently sized from a high-resolution grid associated with an AOI that is 200 square kilometers. In some embodiments, the resolution of the high-resolution grid may be determined with relation to the dimensions of the AOI. For example, a first grid associated with an AOI that is 200 square kilometers may have a different resolution quality as compared to a second grid associated with a second AOI that is 1000 square kilometers. In some embodiments, the resolution of the high-resolution grid and the size of the high-resolution grid may be related to each other. For example, a grid with a relatively high resolution may have a different size than a grid with a relatively low resolution. Similarly, the site characterization system 120 may allow for user input via the I/O ports 130 to adjust the resolution quality and size of the grid associated with the AOI. In some embodiments, the site characterization system 120 may store the grid at a first size and a first resolution and display the grid to a user via the display 132 at a second size and a second resolution. In some embodiments, the grids may be two-dimensional or three-dimensional.

The high-resolution grid may be populated with the input data to upscale the input data across the AOI. In some embodiments, the site characterization system 120 may upscale the input data by selecting grid element values based on nearby input data points (e.g., gridding). Gridding may use linear interpolation methods, nonlinear interpolation methods, statistical methods (e.g., kriging), and the like to characterize an AOI by the received lithological input data. In some embodiments, the site characterization system 120 may apply gridding algorithms to the high-resolution grid to populate the grid based on one or more of the data input types. For example, the rock porosity data taken at one or more locations within the AOI may be upscaled through a high-resolution grid that populates the rock porosity data across the AOI. Referring back to block 152, the received sediment and rock layer dataset may include the upscaled rock porosity data. Similarly, the received sediment and rock layer dataset may include the upscaled lithological data from the one or more data input points.

At block 154, the site characterization system 120 may generate one or more updated datasets by applying forward stratigraphic modeling techniques to the one or more sediment datasets and the one or more rock layer datasets. The forward stratigraphic modeling techniques may allow the site characterization system 120 to determine a second state of the AOI based on a first state of the AOI, where the first state proceeds the second state. For example, the one or more sediment and rock layer datasets may include lithological data taken from an AOI ten years ago. By employing forward stratigraphic modeling techniques, the site characterization system 120 may generate an updated dataset based on the one or more sediment and rock layer datasets that may include lithological data at a date in time after the first state. In this way, the site characterization system 120 may make predictions as to the lithological data associated with the sediment and the one or more rock layers 14 across an AOI over a period of time.

At block 156, the site characterization system 120 may generate a geological process model based on the one or more updated datasets. The geological process model may allow the site characterization system 120 to test multiple geological scenarios (e.g., earthquakes, water current, air current, sediment erosion, sediment deposition, etc.). That is, the site characterization system 120 may use one or more geological scenarios to perform calculations associated with the geophysical properties of the one or more rock layers 14. The geological process model may indicate that the one or more rock layers 14 may physically change and the lithological properties of the one or more rock layers 14 may be altered by one or more geological scenarios over a period of time. For example, the geological process model may indicate that a portion of a first layer composed of loose silt may be eroded and the depth of the first rock layer surface 24 may increase with respect to time. The geological process model may be one-dimensional, two-dimensional, or three-dimensional. That is to say, different types of data may be more easily visualized in three-dimensional model as opposed to a two- or one-dimensional model. For example, if the user is interested in the rock porosity data at a particular depth, over a period of time, the site characterization system 120 may generate a two-dimensional model that acts as a slice of the AOI at the particular depth. Conversely, a three-dimensional model may be better suited to visualize the rock porosity data at multiple relevant depths across the AOI.

In some embodiments, the geological process model may incorporate one or more data input types from the updated dataset. The site characterization system 120 may incorporate some input data types at a different proportion relative to some other data input types. In some embodiments, the site characterization system 120 may generate one or more geological process models associated with the one or more data input types of the updated dataset. For example, the site characterization system 120 may generate a first geological process model based on the updated rock porosity data and a second geological process model based on the updated rock density data.

At block 158, the site characterization system 120 may predict one or more geological features associated with the AOI by applying a machine learning algorithm to the geological process model. The geological features may include rock layer tectonics, rock layer surface variation (e.g., trenches, ridges, rises, islands, etc.), rock layer age, rock layer strength, rock layer stability, and the like. The geological features may be associated with one or more depths across the AOI, such as the transition zone, shallow sediments, deep sediments, shallow rock layers, deep rock layers, and the like. The geological features may include characteristics of the one or more rock layers that are relevant in the generation of site characterization across the AOI. The machine learning algorithm may incorporate the geological process model as training data for future predictions of the geological features with respect to the geological process model. The machine learning algorithm may continue to update the predicted geological features based on an updated dataset generated by the forward stratigraphic modeling techniques. In this way, the site characterization system 120 may operate iteratively when predicting geological features.

At block 160, the site characterization system 120 may generate a predictive Earth model based on the one or more geological features predicted by the site characterization system 120 at block 158. In some embodiments, the site characterization system 120 may compile the predicted geological features and generate a predictive Earth model that represents the geological features based on the collected predicted geological features. The predictive Earth model may be displayed to a user via the display 132 of the site characterization system 120. In this way, the site characterization system 120 may allow the user to visualize the AOI. The predictive Earth model may use different visual methods to identify different geological features. For example, the first rock layer may be visualized with a darker color while the second rock layer is visualized with a lighter color. In some embodiments, the visualization of the geological feature may relate to the lithological properties of the geological feature. The predictive Earth model may be one-dimensional, two-dimensional, or three-dimensional.

The predictive Earth model may include a model representation of the rock layer tectonics, the rock layer variation (e.g., trenches, ridges, rises, islands, etc.), the rock layer age, the rock layer strength, the rock layer stability, and the like. In some embodiments, the predictive Earth model may include a model of part of or the entire AOI. The predictive Earth model may include a model of the one or more rock layers 14, the one or more rock layer surfaces 16, the body of water 12, the surface of the water 30, and the like.

In some other embodiments, the predictive Earth model may include a portion of the AOI. In some embodiments, the predictive Earth model associated with a first AOI may be joined with a predictive model associated with a second AOI to generate a predictive model associated with a third AOI, where the third AOI is the combined area between the first and second AOI. For example, a first predictive Earth model may be generated for the AOI from a zero-meter depth to a twenty-five-meter depth and a second predictive Earth model may be generated for the AOI from a twenty-meter depth to a fifty-meter depth. The first predictive model and the second predictive model of the example may be joined in order to generate a third predictive model for the AOI from a depth of zero meters to fifty meters. Similarly, a predictive model of a first AOI may be divided into portions of a predictive model.

At block 162, the site characterization system 120 may generate one or more site characterization properties based on the predictive Earth model. The site characterization properties may include sediment prediction for foundational support, quantiles, uncertainty spread, and the like. Site characterization properties may be displayed to the user via a display 132. The site characterization properties for a chosen AOI may be visualized as a heat map for construction, text descriptions of the site, recommended site location coordinates, and the like. The site characterization system 120 may generate a heat map that categorizes the AOI via a gradient. For example, the site characterization system 120 may mark areas of relatively favorable site characteristics in green, areas of relatively unfavorable site characteristics in red, areas in between favorable and unfavorable as a gradient between the two shades, and the like. In some embodiments, the site characterization may be in the form of a recommendation regarding a part or the entirety of the AOI. For example, the site characterization properties may indicate a lack of location coordinates across the AOI suitable for foundation construction. Alternatively, the site characterization system 120 may generate site characterization properties that include specific coordinates as recommendations. These coordinates may be associated with the location points across the AOI that the site characterization system 120 has calculated to be optimal for site construction. The calculations may take one or more different factors into account when quantifying a location point. The factors may include foundation lifespan, observed forces that would act upon the foundation, feasibility of construction (e.g., depth, distance from shore, etc.), and the like.

In addition to the site characterization properties, in some embodiments, the site characterization system 120 may determine a rock strength profile based on the received sediment and rock layer datasets. The site characterization system 120 may then generate the predictive Earth model based in part on the rock strength profile. The predictive Earth model may include foundation stability properties associated with the foundational strength and stability of the one or more rock layers 14.

With the foregoing in mind, FIG. 4 illustrates a flow chart of a method 180 for determining foundation stability properties of an AOI. Although the following description of the method 180 is described as being performed by the site characterization system 120, it should be understood that any suitable computing system may perform the method 180. Additionally, although the method 180 is described in a particular order, it should be noted that the method 180 may be performed in any suitable order.

Referring now to FIG. 4, at block 182, the site characterization system 120 may receive a geological process model associated with the AOI. In some embodiments, the geological process model received via the method 180 may be associated with the geological process model described above with the method 150. In some other embodiments, the geological process model in block 182 may be generated by other methodologies or entities. In any case, the geological process model may contain lithological data associated with the one or more rock layers 14 across the AOI. The lithological data may include lithological density data, lithological hardness data, lithological material composition data, and the like. In some embodiments, the lithological data may be predicted based on known lithological data. The known lithological data may include CPT properties obtained via a CPT survey 34, and the like. Similarly, to the geological process model of block 156, the geological process model of block 182 may be one-dimensional, two-dimensional, or three-dimensional.

At block 184, the site characterization system 120 may receive one or more seismic datasets associated with the AOI. In some embodiments, the seismic datasets may be associated with the received one or more sediment and rock layer datasets described above with reference to the method 150. Similarly, the site characterization system 120 may receive seismic datasets from the marine seismic data surveys 32 for the purpose of determining foundation stability in accordance with the method 180. As such, the site characterization system 120 may incorporate seismic datasets acquired from previous marine seismic data surveys 32 that were recorded for purposes beyond the scope of this disclosure. The seismic datasets may be associated with one or more of the marine seismic data surveys 32 that are conducted at one or more location points across the AOI. The seismic datasets may include the p-wave velocity measurements observed by the streamer sensors 46 of the seismic streamers 44 or other suitable seismic sensors. The p-wave velocities may correspond to time periods in which sound waves travel a distance through one or more rock layers 14.

At block 186, the site characterization system 120 may extract one or more lithological density datasets associated with the AOI based on the geological process model. As mentioned above, the geological process model may contain lithological density data which may be extracted by the site characterization system 120 as a lithological density dataset. The lithological density dataset gives a predicted dataset for the density of the one or more rock layers 14 based on geophysical calculations. The site characterization system 120 may accept additional lithological data (e.g., CPT properties) to calibrate the geological process model. In some embodiments, extracting the lithological density dataset may include creating a copy of the lithological density dataset. In another embodiment, extracting the lithological density dataset may include removing the lithological density dataset from the geological process model.

At block 188, the site characterization system 120 may generate one or more rock layer porosity volume datasets based on the one or more lithological density datasets. The rock layer porosity volume dataset may be associated with the lithological density data. In some embodiments, the lithological density dataset may be a first lithological density dataset. One or more additional datasets may be received by the site characterization system 120 may include a second lithological density dataset. The first lithological density dataset may include the density data associated with the one or more rock layers 14 of the AOI and the second lithological density data may include density data associated with a materially similar rock layer that may not include porosity data. The site characterization system 120 may compare the density observed in the first lithological density dataset to the density observed in the second lithological density dataset. Based on the difference between the first and second lithological density datasets, the site characterization system 120 may generate the rock layer porosity volume dataset. In some other embodiments, the site characterization system 120 may generate the rock layer porosity volume dataset based on the first lithological density dataset alone.

At block 190, the site characterization system 120 may determine the rock strength profile associated with the AOI based on the one or more seismic datasets and the one or more rock layer porosity volume datasets. In some embodiments, determining the rock strength profile may include generating a cross plot between the p-wave velocity data points and the rock layer porosity volume data points. That is, for example, the site characterization system 120 may apply interpolation/extrapolation methods to the cross plot in order to generate a best fit line equation from the relationship between the p-wave velocity data points and the rock layer porosity volume data points. The interpolation method may be a linear interpolation method, a quadratic interpolation method, an exponential interpolation method, and the like. The extrapolation method may be a linear extrapolation method, a quadratic interpolation method, an exponential interpolation method, and the like. The cross plot may generate predicted data points between known data points (e.g., via the interpolation methods), and the cross plot may generate predicted data points beyond known data points (e.g., via the extrapolation methods). In this way, the rock strength profile may be predicted across the AOI for a variety of tested and untested locations alike. In some embodiments, the correlation coefficient obtained on the best fit line equation is in the range of 0.92 to 0.94 when compared to rock strength data points obtained via traditional testing methods across the AOI.

The rock strength profile may include rock strength data associated with the one or more rock layers 14. The rock strength of a rock layer may refer to the maximum stress before fracture of a sample of the rock layer. Traditionally, tests may be performed that place the sample in either tension or compression. In both instances, increasing forces may exert on the sample until failure. Often, rock samples act as brittle solids and fail through shear fracture under compression. A first rock layer 18 with a relatively high rock strength is able to endure larger forces and pressures before fracturing than a second rock layer 20 with a relatively low rock strength. Some factors that may influence the rock strength associated with one or more rock layers 14 include rock porosity, mineral composition, pre-existing stresses in the rock layer, structure, homogeneity, and the like.

At block 192, the site characterization system 120 may generate a predictive Earth model based on the rock strength profile and the geological process model. The predictive Earth model may be in part based on other geological features such as rock layer tectonics, rock layer variations (e.g., trenches, ridges, rises, islands, etc.), rock layer age, rock layer stability, and the like. The predictive Earth model may be displayed to a user via the display 132 of the site characterization system 120. In this way, the site characterization system 120 may allow the user to visualize the AOI. In some embodiments, the predictive Earth model may include a model of the entire AOI. The predictive Earth model may be one-dimensional, two-dimensional, or three-dimensional. The predictive Earth model may include a model of the one or more rock layers, the one or more rock layer surfaces, the body of water, the surface of the water, and the like. The predictive Earth model may use different visual methods to identify different geological features. For example, the first rock layer may be visualized with a darker color while the second rock layer is visualized with a lighter color. In some embodiments, the visualization of the geological feature may relate to the lithological properties of the geological feature.

In some other embodiments, the predictive Earth model may include a portion of the AOI. In some embodiments, the predictive Earth model associated with a first AOI may be joined with a predictive model associated with a second AOI to generate a predictive model associated with a third AOI, where the third AOI is the combined area between the first and second AOI. For example, a first predictive Earth model may be generated for the AOI from a zero-meter depth to a twenty-five-meter depth and a second predictive Earth model may be generated for the AOI from a twenty-meter depth to a fifty-meter depth. The first predictive Earth model and the second predictive Earth model of the example may be joined to generate a third predictive Earth model for the AOI from a depth of zero meters to fifty meters. In some other embodiments, a first predictive Earth model of a first AOI may be divided into portions of a predictive Earth model as one or more partial predictive Earth models.

Similarly to how the geological features determined using the method 150 provided the basis for generating the predictive Earth model in block 160, the rock strength profile determined using the method 180 may provide the basis for generating the predictive Earth model in block 192. In some embodiments, the rock strength profile determined via the method 180 is included in the geological features predicted via the method 150.

At block 194, the site characterization system 120 may generate foundation stability properties based on the predictive Earth model. The foundation stability properties may include lithological data associated with the one or more rock layers 14 at multiple depths across the AOI. For example, the lithological data may include a rock strength for the one or more rock layers 14, rock porosity, sediment solubility, rock layer erosion rate, plate shift probability, rock layer aging, and the like. The foundation stability properties may be used in the construction of one or more offshore structures. For example, the turbine foundation 68, the offshore cable array 80, the offshore substation 77, the offshore export cable 84, the onshore export cable 86, and the like may have some a part of the respectively chosen construction location determined via the foundation stability properties.

Foundation stability properties may be displayed to the user via a display 132. The foundation stability properties for a chosen AOI may include a heat map for construction, textual properties describing the site, recommended site location coordinates, etc. The site characterization system 120 may generate a heat map that categorizes the AOI via a gradient. For example, the site characterization system 120 may mark areas of relatively good foundational stability in green, relatively decent foundational stability in yellow, and relatively bad foundational stability in red, etc. In some embodiments, the foundational stability properties may be in the form of a recommendation regarding a portion or the entirety of the AOI. For example, the foundational stability properties may include a recommendation that there are no location coordinates across the AOI suitable for foundation construction. Alternatively, the site characterization system 120 stability properties that include specific coordinates as may generate foundational recommendations. These coordinates may be associated with the location points across the AOI that the site characterization system 120 has calculated to be optimal for site construction. The calculations may take one or more different factors into account when quantifying a location point. The factors may include foundation lifespan, observed forces that would act upon the foundation, feasibility of construction (e.g., depth, distance from shore, etc.), and the like.

Similarly to how the predictive Earth model of the method 150 provided the basis for generating the site characterization properties in block 162, the predictive Earth model of the method 180 may provide the basis for generating the foundation stability properties in block 194. In some embodiments, the foundation stability properties determined via the method 180 are included in the site characterization properties predicted via the method 150.

Technical effects of the presently disclosed embodiment include determining site characterization properties and rock strength properties in a more computationally efficient manner. That is, previous methods involved generating predictive Earth models that are not bounded by the scope of AOI and that demand large amounts of time and energy to fully model. The embodiments presented herein may provide more accurate results by integrating the geological process model as training data when propagating properties throughout the predictive Earth model. The site characterization system 120 may direct processing power towards generating predictive Earth models associated with the geological properties determined to be most relevant to site characterization. In this way, the site characterization system 120 may minimize the computing time to generate the predictive Earth model by disregarding data that is not relevant to the AOI and not relevant to the geological properties. The selectivity in scope imposed by the training data provides more relevant data in a more computationally efficient manner.

While only certain features of disclosed embodiments have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method, comprising:
receiving, via at least one processor, a dataset comprising one or more cone penetrative test (CPT) properties associated with an area of interest (AOI) that corresponds to a seafloor;
generating, via the at least one processor, a geological process model comprising one or more rock layers and sediment information across the AOI based on one or more forward stratigraphic modeling techniques and geological information associated with the AOI; and
applying, via the at least one processor, a machine learning algorithm to the geological process model to generate a predictive Earth model indicative of one or more site characteristics properties associated with a volume across the AOI.

2. The method of claim 1, wherein the one or more site characteristics properties comprise one or more probability quantities, one or more uncertainty volumes, or any combination thereof associated with the one or more rock layers in the volume across the AOI.

3. The method of claim 1, wherein the geological information comprises sediment data, rock layer data, or both.

4. The method of claim 1, wherein the geological information comprises erosion data, current data, salinity data, rock strength data, rock age data, rock density data, rock corrosiveness data, rock porosity data, or any combination thereof.

5. The method of claim 1, comprising:
receiving, via the at least one processor, seismic data associated with the AOI;
extracting, via the at least one processor, lithological density data associated with the AOI based on the geological process model;
generating, via the at least one processor, rock layer porosity volume data associated with the AOI based on the lithological density data;
determining, via the at least one processor, a rock strength profile across the AOI based on the seismic data and the rock layer porosity volume data; and
updating, via the at least one processor, the predictive Earth model to include one or more rock strength properties across the volume of the AOI based on the rock strength profile.

6. The method of claim 1, comprising:
generating predicted lithological dataset associated with the AOI by applying one or more forward stratigraphic modeling techniques to the dataset; and
generating the geological process model based on the predicted lithological dataset.

7. The method of claim 1, wherein the geological process model is representative of one or more physical changes of one or more rock layers in the AOI over a period of time.

8. The method of claim 1, wherein the geological process model is used as training data for the machine learning algorithm to predict the one or more site characteristics properties associated with the volume across the AOI.

9. A computer program comprising computer-executable instructions that, when executed, are configured to cause at least one processor to perform operations comprising:
receiving seismic data associated with an area of interest (AOI) and a geological process model indicative of information related to one or more rock layers and sediment information across an area of interest (AOI);
extracting lithological density data associated with the AOI based on the geological process model;
generating rock layer porosity volume data associated with the AOI based on the lithological density data;
determining a rock strength profile across the AOI based on the seismic data and the rock layer porosity volume data; and
generating a predictive Earth model comprising one or more rock strength properties across a volume of the AOI based on the rock strength profile and the geological process model.

10. The computer program of claim 9, wherein the seismic data comprises one or more p-wave datasets associated with the one or more rock layers.

11. The computer program of claim 10, wherein the rock strength profile is determined based on a best fit line equation associated with a cross plot between the one or more p-wave datasets and the rock layer porosity volume data.

12. The computer program of claim 9, wherein the rock strength profile is determined based on a cross plot between one or more p-wave velocity data points of the seismic data and one or more rock layer porosity volume data points of the geological process model.

13. The computer program of claim 12, wherein the computer-executable instructions are configured to cause the at least one processor to perform operations comprising applying one or more interpolation methods, one or more extrapolations methods, or both to the cross plot to generate one or more predicted values for the one or more rock strength properties.

14. The computer program of claim 9, wherein the geological process model is representative of one or more physical changes of one or more rock layers in the AOI over a period of time.

15. A computer program comprising computer-executable instructions that, when executed, are configured to cause at least one processor to perform operations comprising:
receiving a dataset comprising one or more cone penetrative test (CPT) properties associated with an area of interest (AOI) that corresponds to a seafloor;
generating, via the at least one processor, a geological process model comprising lithological density data associated the AOI based on one or more forward stratigraphic modeling techniques and geological information associated with the AOI;
applying, via the at least one processor, a machine learning algorithm to the geological process model to generate a predictive Earth model indicative of one or more site characteristics properties associated with a volume across the AOI; and
updating the predictive Earth model to include one or more rock strength properties across the volume of the AOI based on seismic data associated with the AOI and the lithological density data.

16. The computer program of claim 15, wherein the computer-executable instructions are configured to cause the at least one processor to perform the operations comprising:
generating rock layer porosity volume data associated with the AOI based on the lithological density data;
determining a rock strength profile across the AOI based on the seismic data and the rock layer porosity volume data; and
updating the predictive Earth model to include the one or more rock strength properties across the volume of the AOI based on the rock strength profile.

17. The computer program of claim 15, wherein the one or more rock strength properties comprises stresses, strains, or both associated with material failure of one or more rock layer across the volume of the AOI.

18. The computer program of claim 15, wherein the geological process model is used as training data for the machine learning algorithm to predict the one or more site characteristics properties associated with the volume across the AOI.

19. The computer program of claim 15, wherein the geological process model is generated based on a predicted lithological dataset associated with the AOI, wherein the predicted lithological dataset is determined by applying one or more forward stratigraphic modeling techniques to the dataset.

20. The computer program of claim 15, wherein receiving the dataset comprises a high-resolution grid generated by upscaling the one or more CPT properties.
